(19) United States
(12) Patent Application Publication
(10) Pub. No.: US 2002/0133586 A1
(43) Pub. Date: Sep. 19, 2002

(54) Method and device for monitoring data traffic and preventing unauthorized access to a network

(76) Inventors: Carter Shanklin, Woodland, CA (US); Michael Nadler, Sacramento, CA (US); Mark Ontiveros, Woodland, CA (US)

Correspondence Address: DKW LAW GROUP, P.C., 58TH FLOOR - USX TOWER, 600 GRANT STREET, PITTSBURGH, PA, 15219, US

(21) Appl. No.: 09/844,794

(22) Filed: Apr. 27, 2001

Related U.S. Application Data
(63) Continuation-in-part of application No. 09/761,499, filed on Jan. 16, 2001.

(51) Int. Cl. G06F 15/16

(52) U.S. Cl. 709/224; 709/225; 709/229; 713/201

(57) ABSTRACT

A method and device for protecting a network by monitoring both incoming and outgoing data traffic on multiple ports of the network, and preventing transmission of unauthorized data across the ports. The monitoring system is provided in an non-promiscuous mode and automatically denies access to data packets from a specific source based upon an associated rules table. All other packets from sources not violating the rules are allowed to use the same port. The monitoring system processes copies of the data packets resulting in minimal loss of throughput. The system is also highly adaptable and provides for dynamic writing and issuing of firewall rules by updating the rules table. Information regarding the data packets is captured sorted and cataloged to determine attack profiles and unauthorized data packets.

The present invention is a continuation-in-part of U.S. patent application Ser. No. 09/761,499 entitled “METHOD AND DEVICE FOR MONITORING DATA TRAFFIC AND PREVENTING UNAUTHORIZED ACCESS TO A NETWORK” filed Jan. 16, 2001.

### FIELD OF THE INVENTION

The present invention relates to monitoring data traffic, and more particularly to identifying specific network data traffic intended to attack data ports and the like, as well as preventing the transmission of such attack data across the data ports. http://www.brownsville-revival.org/media/index.htm

### BACKGROUND OF THE INVENTION

The increase of data traffic across the Internet, including the growth in the number of users of the Internet, as well as the number of merchants and businesses having a web presence, has resulted in a need to provide individualized management and monitoring of the data traffic flow. Merchants and businesses are realizing the increased need to monitor traffic flow, as the number of attacks on the web sites of these merchants and businesses has increased dramatically.

The number of “hackers” continues to increase, and attacks on web sites are becoming a more common occurrence. Merchants and businesses are particularly concerned with obtrusive attacks on their web pages. In these attacks, “hackers” use all ports of a network system in an attempt to gain unauthorized access. Such attacks include for example denial of service (DoS) attacks (which include Buffer Overflow attacks, SYN attacks, Ping of Death attacks, Teardrop attacks and Smurf attacks), which have potentially serious ramifications. DoS attacks attempt to shut down a network by flooding it with data traffic. These attacks attempt to exploit the limitations in the Transmission Control Protocol/Internet Protocol (TPC/IP) protocols and deprive the networks of resources, and can, in cases of large attacks, force a web site to temporarily cease operation. Such attacks can also destroy programming and files in a computer system. The “hackers” that attack these web sites are not necessarily interested in obtaining confidential information from the web sites, but are interested in shutting down the sites by flooding a particular web-page with a large number of “hits,” resulting in an overload of the server for the web site of the merchant or business. This results in an interruption in access to the site by consumers and essentially shuts down the web site, which for purely online businesses, is shutting down the entire business. For merchants and businesses that rely on the Internet for a large portion of their sales or for all of their sales, any period of non-operation is extremely costly, in both time and money. Other attacks include routing-based attacks and unauthorized access to certain protected services.

Attempts have been made to develop systems to prevent unauthorized access to or from networks. Most commonly, firewalls are provided to control access to networks and prevent access by unauthorized users. Essentially, these firewalls are configured with a set of predetermined rules, which are usually static, and examine data traffic traversing the firewall to determine whether or not access should be denied based upon the predetermined rules. Examples of firewalls include packet filters, which look at each packet transmitted to a network to determine whether it should be accepted or rejected based on a set of pre-defined rules; application gateways, which provide security to particular applications such as File Transfer Protocol (FTP) servers; circuit-level gateways, which provide security when certain connections, such as a TCP connection are established, thereafter allowing data packets to flow between hosts without further checking; and proxy servers, which capture all data packets entering or leaving a network, thereby hiding the true network addresses. These firewalls are typically used in connection with a network policy and other authentication mechanisms that define the set of rules. Also, these firewalls can be implemented by numerous devices, including routers, personal computers or Internet hosts.

Attacks on a network may occur from an outside source, but may also occur from a source within the network. Therefore, firewalls must provide for monitoring of traffic from both sides of the network. Even though networks rely on security methods other than firewalls to protect their systems, these methods do not always effectively protect the networks due to, for example, failure to update monitoring systems or complexity in the networks. This results in networks that are more susceptible to attack. A firewall adds to network protection and provides another line of defense against attacks.

Although different types of firewalls exist, they are generally provided with static rules that limit the adaptability of the firewall. Also, these firewalls examine each of the actual packets, which reduces data traffic throughput, and generally only examine data traffic in one direction across network ports. Further, the firewalls typically deny access to and from an entire data port when detecting unauthorized data, instead of denying access to or from a single Internet Protocol (IP) address, which results in an unnecessarily broad denial of access.

### SUMMARY OF THE INVENTION

The present invention provides a device and method for protecting a network by monitoring data traffic transmitted from and received by a network using a non-promiscuous mode and preventing unauthorized access using dynamic rules, while maintaining network performance and minimizing administrative costs. The present invention monitors data traffic to detect unauthorized data packets, and thereafter denies access to unauthorized data packets. Essentially, data traffic patterns that exceed user configurable parameters are denied access to the monitored network. One embodiment of the present invention may be referred to as a packet daemon embodiment (the “Pktd” embodiment) and another embodiment may be referred to as a Traffic Limiting Intrusion Detection System (the “TLIDS” embodiment, and each is discussed below.

The Pktd Embodiment

In one embodiment, the invention is directed to an intrusion detection system (IDS) using a packet daemon that captures, sorts, and catalogs network traffic on a packet-by-packet basis. The packets are preferably captured for inspection by an interface, for example, by using available libpcap libraries. These libraries are further preferably used in connection with a parsing engine, which may be provided as a module that interfaces with the libpcap library (e.g., Practical Extraction and Reporting Language (Perl)). The combination results in a dynamically configurable firewall that can parse and trace network protocol hacking patterns using the capturing and parsing engines.

The libpcap C library is an American National Standards Institute (ANSI) C code compliant library that reads in network packets and provides basic software “hooks” or access points into various levels of package types including: physical data frames such as Ethernet, logical data frames such as Logical Link Control, connectionless datagrams such as User Datagram Protocol (UDP), or stateful datagrams such as Transmission Control Protocol (TCP). Perl is preferably used to parse through the basic data packets or datagrams and strip off information that slows down the packet daemon. Perl also preferably provides the source, destination, port, and protocol types for analysis and determination of attack profiles. The packet daemon preferably uses this basic protocol information collected from the packet headers to determine and issue firewall rules that provide the adaptive firewall functionality.

Specifically, the IDS with the packet daemon of the present invention, for use with, for example an adaptive firewall, copies data packets traversing ports of a network to determine whether access to or from a particular source should be denied. Preferably, one IDS having a packet daemon is provided for each port. In particular, a configuration file controls the parameters of operation, including for example sample rate. Based upon the security needs of the network, a data packet count threshold and a sample time are preferably provided to define the denial conditions for the network. In operation, if the number of packets from any one source exceeds the data packet count threshold during the sample period, all data packets from that source to a specific destination are denied access to the network port. However, other data traffic can continue to access the network through that port.

Thus, the present invention provides a method and device for monitoring network traffic that has adaptability and provides dynamic rule making. The preferred IDS in connection with a firewall also provides automatic denial of access to data packets meeting the denial conditions, which denial is removed after a lockout period, if the source is no longer transmitting attack data packets. The IDS with the packet daemon is preferably reset after the sample time and continues to monitor data traffic flow.

The IDS may be provided as part of and integrated into a larger data traffic detection and monitoring system. Preferably, a separate IDS is activated for each monitored data port of, for example, a router.

The TLIDS Embodiment

The TLIDS embodiment of the present invention provides an improved set of responses where the denial conditions have been met over those of the Pktd embodiment. The TLIDS embodiment also introduces greater utility, flexibility and speed in thwarting denial of service attacks.

In the Pktd embodiment, the response was primarily directed to denial of access when denial conditions where met, which denial was removed after a lockout period if the transmitting source was no longer transmitting attack data packets.

While denial certainly remains a response in the TLIDS embodiment of the present invention, newly added responses include an “alert” response which entails sending an alert to the system administrator or other supervisory personnel or devices, a “throttling” response which queues packets and sends them out at a controlled rate, and a “redirection” response, wherein the attack from the source is redirected to another destination selected by the system administrator or other supervisory personnel or devices so that the attack can be captured and analyzed as desired or required.

The newly developed responses are made possible by the TLIDS embodiment because it does not simply look at source and destination, determining the number of packets from each source traversing the data ports during a predetermined period of time and denying access to the data ports to data packets from a particular source if the number of packets traversing the ports from that source was greater than a predetermined number during the predetermined period of time. Instead, the present inventors have realized that an analysis of the protocol used to send the data packets is also important, as certain types of protocols by their nature generate high traffic while others do not. Analyzing traffic flow versus protocol employed provides a much more accurate determination and identification of denial of service attacks. Thus the present invention monitors source address, destination address, destination port, source port and protocol, and when parameters are exceeded indicating an attack is in progress, it can respond with an alert, denial of service, request for throttling, redirection and combinations thereof in response to the attack.

In addition to greater flexibility in response and greater accuracy in identifying the attack, the present invention also introduces flexibility in that the previously developed system denied all service from a source when parameters were exceeded during the lockout period. The present invention, by analyzing protocol, can deny service based on protocol not simply source address, thus a source that is transmitting both attack on with a first protocol and non-attack data packets via a second protocol can be permitted to continue to sending the non-attack data packets. Faster analysis is permitted using a Radix decisional tree structure.

While the principal advantages and features of a present invention have been explained above, a more complete understanding of the invention may be attained by referring to the description of the preferred embodiments which follow.

### BRIEF DESCRIPTION OF THE DRAWINGS

FIG. 1 is a block diagram of a typical system in which the monitoring system constructed according to the principles of the present invention is implemented;

FIG. 2 is a block diagram of the sorting and counting functions of the present invention;

FIG. 3 is a block diagram illustrating an adaptive firewall operating in connection with an IDS and packet daemon constructed according to the principles of the present invention;

FIG. 4 is a flow chart of the packet daemon algorithm of the present invention;

FIG. 5 is a flow chart of a main thread of the present invention;

FIG. 6 is a flow chart of an ADS connections thread and a packet capture thread of the present invention;

FIG. 7 is a flow chart of a per-second thread of the present invention;

FIG. 8 is a flow chart of an increment count thread of the present invention; and

FIG. 9 is a flow chart of a signal catching thread of the present invention.

FIG. 10 illustrates the merger of internal nodes.

FIG. 11 is an illustration of the threads and communication channels of the present invention.

### DETAILED DESCRIPTION OF PREFERRED EMBODIMENTS

The Pktd Embodiment

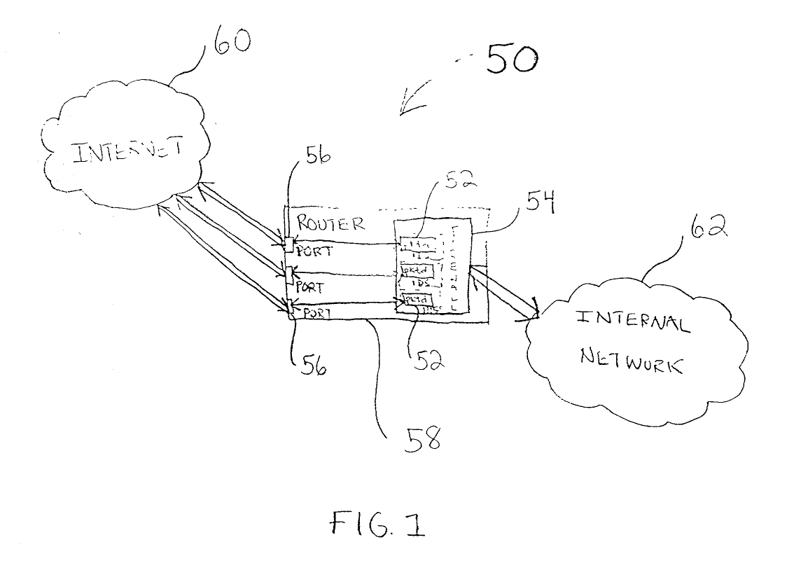

A typical system in which the preferred embodiment of a data traffic monitoring system of the present invention for protecting networks may be implemented is shown schematically in FIG. 1 and indicated generally as reference numeral 50. As shown, the preferred monitoring system 50 may be provided by packet daemons (pktd) 52 as part of an IDS, which are provided as part of a firewall 54, with a separate packet daemon monitoring each port 56 or a network. The preferred firewall 54 and packet daemons 52 may be provided in connection with a mid-network switching device, such as a router 58 which provides communication of data packets between the Internet 60 and the internal network 62. In operation the router 58 activates the specific IDS 52 associated with the ports 56 to be monitored.

Although the monitoring system 50 is preferably implemented using packet daemons 52 and is shown as implemented in a router 58, it may be provided in connection with other components of a network to thereby monitor data traffic. The monitoring system 50 of the present invention is preferably provided as a software and hardware adaptive firewall 54 addition to, for example, a switch router 58, which detects and denies data traffic with patterns that are in contrast to normal traffic patterns (i.e., exceed user defined configurable parameters), thereby preventing hacking attacks on networks. Depending upon the security requirements of the network, the present invention may be configured to detect different levels of attacks. The preferred packet daemon of the IDS 52 of the present invention uses the information it collects to issue firewall rules that make up the adaptive firewall functionality.

The monitoring system 50 of the present invention is preferably provided in a multi-threaded design. This allows each thread to execute independently of the other threads, thereby increasing performance. Preferably, each thread shares the same data space with the other threads, resulting in simplified inter-process communication. Critical data structure (e.g., packet information to analyze to determine if the packets exceed user defined parameters) are protected using semaphores, which also facilitate coordination and synchronization of the multi-threaded processes.

In the most preferred embodiment, six threads handle the various functions of the monitoring system 50. Specifically, the following threads are preferably provided:(1)Main Thread: initializes IDS data structures, activates the other threads, and waits for the other threads to complete their processes; (2)ADS connections thread: sends buffers to ADS, if ADS is present; (3)Packet Capture Thread: processes each packet, updates hit counts, queues lockout start commands to the per-second thread, extracts various fields, buffers the fields for transmission to an Anomaly Detection System (ADS), and notifies ADS connection thread to send buffers; (4) Per-second thread: runs each second, starts and stops lockout periods, and clears “hit” count table as configured; (5)Increment count thread: to determine a lock-out condition; and (6) Signal Catching Thread: re-reads configuration file, handles IDS 52 process cleanup and termination.

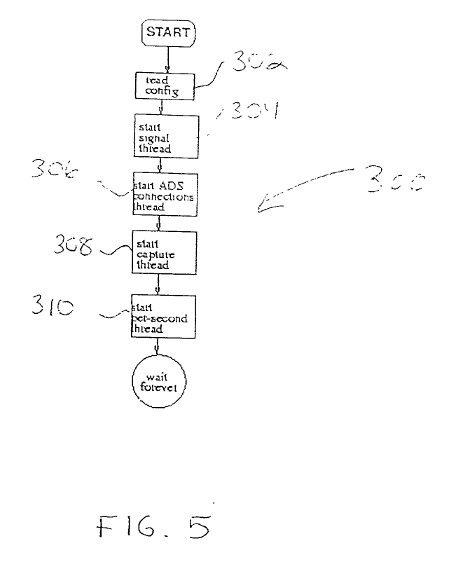

More specifically, the main thread is indicated generally as 300 in FIG. 5. This thread determines whether any special instructions are required to be processed at the read config step 302. The signal catching thread is then activated at the start signal thread step 304. At the start ADS connections step 306, the ADS connections thread is activated. The packet capture thread is then activated at the start capture thread step 308. Then, the per-second thread is activated at the start per-second thread step 310. Once activated by these threads, the IDS 50 remains active until otherwise instructed.

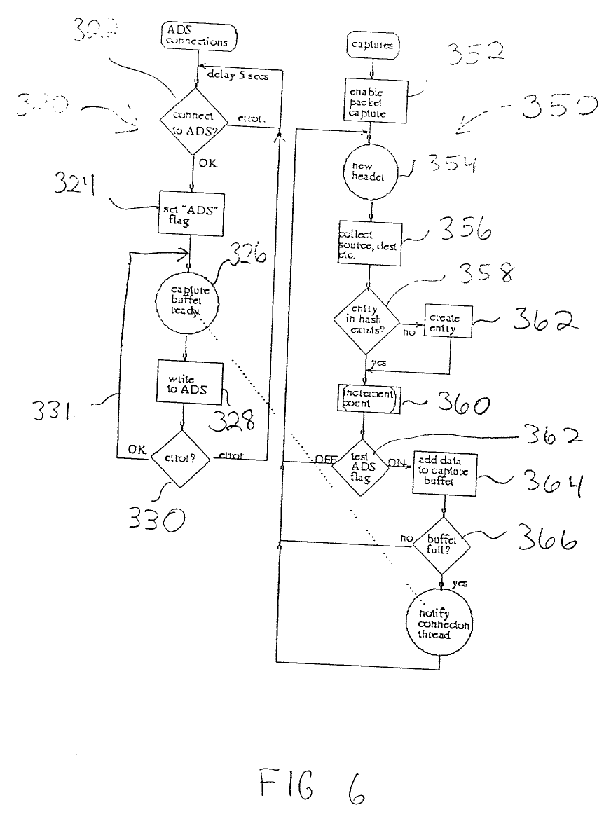

The ADS connections thread 320, as shown in FIG. 6, determines whether connection to the ADS is required at step 322, and if so, a “flag” is set at step 324. The capture buffer then waits at step 326 before writing to the ADS at step 328 until instructed by the packet capture thread 350 that the capture buffer is full. If the write to the capture buffer is activated and completed successfully, the ADS connections thread 320 waits for another command from the packet capture thread 350 to write to the capture buffer. If an error 330 is received, then preferably a five second delay is provided and the ADS connections thread 320 determines whether connection to the ADS is required at 322. If no error is received, the ADS connection thread returns procedurally along arrow 331 to the capture buffer step 326.

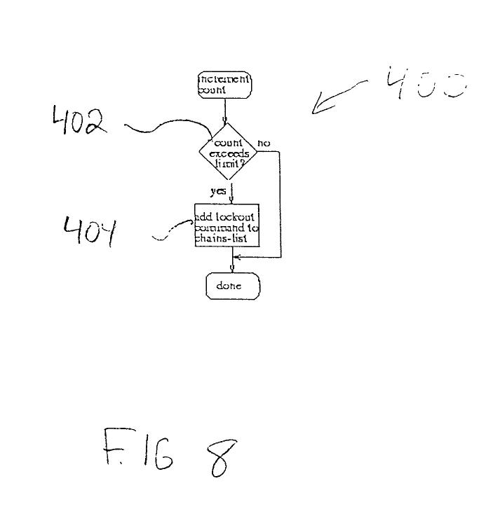

With respect to the packet capture thread 350 as shown in FIG. 6, the packet capture function is enabled at step 352. When a new data packet is received with a new header at step 354, the necessary header information as described herein is collected at step 356. Essentially, a hook from the Lib PCap library provides an indication when a new data packet received and header data needs to be collected. Therefore, the packet capture thread 350 waits until a packet is received, which is preferably provided as a call-back function, and thereafter collects the necessary header information at step 356. The packet capture thread at step 358 determines whether the particular source and destination address pair are already provided a count value in a hash table. If yes, the value is incremented by one at step 360. If not, an entry is created at step 362 with the initial count preferably set at one. The count function is preferably provided by the increment count thread 400 shown in FIG. 8. This thread determines whether the count exceeds a predetermined limit or threshold at step 402. If the limit has not been exceeded, then the increment count thread is done. If the count exceeds the limit or threshold, then at step 404 a lockout command is added to the chains list.

Then, preferably, if the ADS flag is set at step 362, which flag is set by the ADS connections thread 320, packet data is added to the capture buffer at step 364. If the buffer is not full at step 366, then the packet capture thread 350 waits for a new data packet. If the capture buffer is full, then the ADS connections thread 320 is notified at the capture buffer ready step 326, and the data is written to the ADS at 328. Preferably, multiple capture buffers are provided, such that one capture buffer is writing to the ADS while another is receiving new header information.

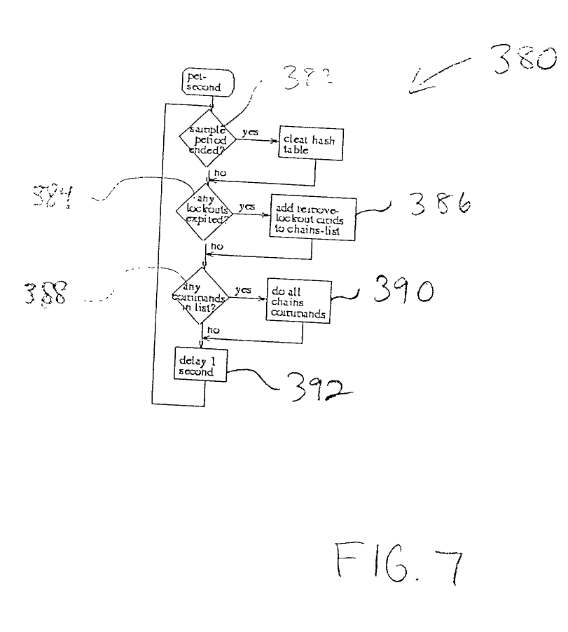

The per-second thread 380, as shown in FIG. 7, determines whether the sample period has ended at step 382. The default sample period is preferably ten seconds. If the sample period has ended, the hash table is reset (i.e., all values with respect to the count for any source and destination address pair is cleared). If the sample period has not expired, then at step 384 a determination is made as to whether any lockouts have expired. If any lockouts have expired, then at step 386, a remove lockout command is added to a chains-list. The default period of lockout for a source and destination address pair is preferably twenty minutes. Thereafter, or if no lockouts have expired, the per-second thread 380 determines at step 388 whether any commands in the chains list are outstanding. These commands include, for example, a new lockout command from the increment count thread 400 or a remove lockout command from the per-second thread 380. If yes, then at step 390 the chain commands are executed. If no, then a one second delay is preferably provided at step 392 and a determination is again made at step 382 as to whether a sample period has ended.

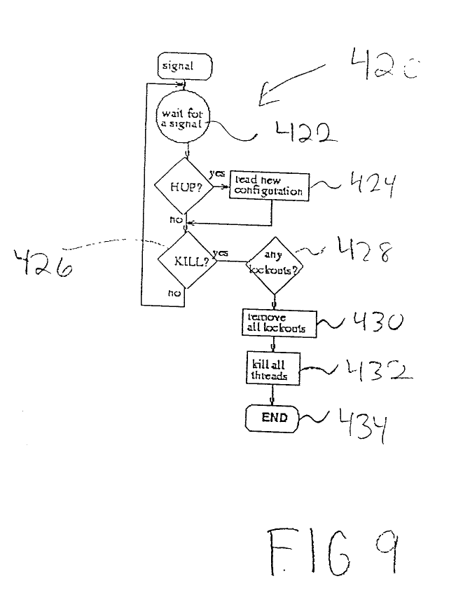

With respect to the signal catching thread 420 as shown in FIG. 9, the thread waits for signal at step 422. This signal is preferably a UNIX signal. If a hang-up (HOP) signal is received, then at step 424 a new configuration file is read by the IDS 50. This includes if a user changes the settable parameters, such as for example the count threshold or sample period. The signal catching thread 420 at step 426 determines whether a kill signal has been received. If yes, then a determination is made at step 428 as to whether any lockouts exist, and if yes, the lockouts are removed at step 430, all threads are deactivated at step 432, and the IDS 50 is thereby deactivated as step 434. If no kill command is received, the signal catching thread 420 waits for another signal at step 422.

Thus, the present invention provides for monitoring or listening to all traffic on a particular physical network interface. As described herein, the monitoring system 50 of the present invention is preferably provided as an IDS having a packet daemon 52, thereby allowing it to work in the background performing the specified operation at predefined times, while transferring data to smaller programs for processing. A packet daemon 52 as part of an IDS is preferably provided at each port of the interface and is preferably configurable by a specific configuration file that controls the operation and monitoring processes of the packet daemon. This configuration file controls specific parameters of the packet daemon 52, including for example sample rate, logging, and lock-down rate.

As shown in FIG. 1, a plurality of multi-threaded packet daemons 52 as described herein are preferably provided when a device, such as a router 58 has multiple interfaces or ports 56. The preferred IDS is therefore preferably non-promiscuous. In operation, when a particular IDS 52 is activated with an associated packet daemon for a particular port 56, preferably only data packets destined for the particular port's 56 hardware MAC address are captured. In the most preferred embodiment, IP and Address Resolution Protocol (ARP) data packets are captured by the packet capture thread 350 and processed by the packet daemon of the IDS 52 to determine if the data packets are allowed access to the network. Specifically, with respect to the packet daemons, each preferably reads from the data traffic stream of its port every millisecond. The packet daemons sort, count and catalog individual packets, and associated information, depending upon the configuration of the web-interface and the requirements of the network, as described herein. Preferably, the sorting and counting of data packets occurs in Random Access Memory (RAM) memory, while the cataloging of data packets is written to a solid-state disk with an access time of preferably 0.01 milliseconds or less, which is then preferably provided to a relational database management system (RDBMS). The RDBMS allows for the creation, updating and administering of a relational database.

It should be noted that any processing of data packet information is performed on copies of the data packets so as to maintain throughput of data traffic. More preferably, only the data packet header is captured from a captured packet and copied for processing. Preferably, specific fields of interest are extracted from the header by the packet capture thread 350 to determine whether the data should be denied access, using the per-second thread 380 and the increment count thread 400. In one embodiment an Anomaly Detection System (ADS) is provided and the extracted header fields are separately buffered and periodically transmitted to the ADS by the ADS connections thread 320 at step 328. In another embodiment, the ADS is not provided and the buffering process is disabled.

In operation, when the ADS is provided, the IDS preferably automatically establishes communication with the ADS in each instance when the ADS is activated. With the ADS activated, the following fields are preferably extracted from the packet header for processing: (1) Ethernet type; (2) source and destination MAC addresses; (3) source and destination IP addresses; (4) protocol type; (5) source and destination ports (only for IP protocols TCP and UDP); and (6) packet length.

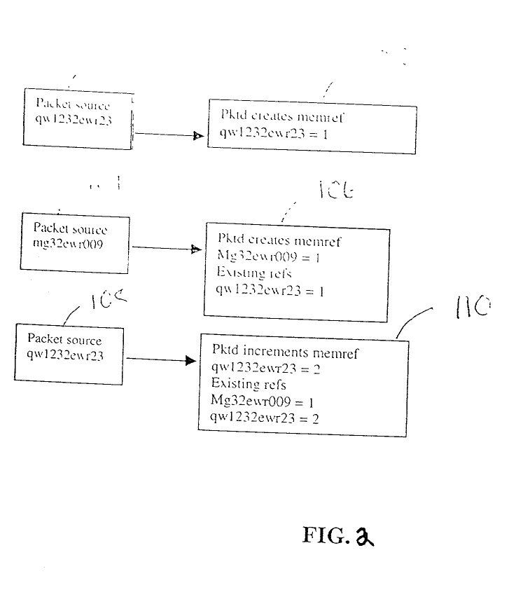

Referring now to FIG. 2, and the operation of the preferred packet daemon of the IDS, the preferred packet daemon creates memory references to each packet source Media Access Control (MAC) address in a hash table, wherein keys (which are the part or group of the data by which it is sorted, indexed and cataloged), are mapped to array positions. As a result of sorting in memory (i.e., processing copies of the data packets), each dedicated packet daemon can sort packet counts on each port at near real-time speed.

A “hit-count” table is preferably created in memory to count the number of times a particular pair of source and destination IP addresses is detected. Entries are stored using a hash table, keyed by the source and destination addresses. In operation, if the “hit” count exceeds a configurable threshold, all traffic between the source and destination endpoints is disabled for a configurable lockout period. When the lockout period ends, traffic between the endpoints is re-enabled. The IDS of the monitoring system 50 preferably generates a system log message when a lockout period begins or ends.

The “hit-count” table is preferably cleared after a configurable sample period has elapsed by the per-second thread 380. The sample period default may be, for example, ten seconds. It should be noted that clearing the “hit-count” table does not affect any lockouts currently in progress.

With respect more specifically to the “hit-count” table, each time a data packet is received, a preferred algorithm as described herein creates a new reference index (if one does not already exist) or increments the existing reference (i.e., counting packets). For example, as shown at 100 in FIG. 2, the packet daemon identifies the packet source address qw1232ewr23 and at 102 creates a memory reference (memref) for that source address. At 104 the packet daemon identifies the source address of the next data packet traversing the port being monitored by the packet daemon, in FIG. 2, the source address being mg32ewr009. At 106 another memref is created for this source address. Therefore, at 104 each of the memrefs are equal to 1, representing that one data packet from each of the sources identified has traversed the data port of interest. At 108, another packet from source address qw123ewr23 is identified, and as shown at 110, the corresponding memref for that address is incremented. So, if for example the threshold data packet value is 1000 for the sample time (e.g., 10 milliseconds), and source address qw1232ewr23 exceeds the threshold in this period (e.g., memref qw1232wer23=1001), then access to the port being monitored will be denied to packets from that source. It should be noted that the source may be transmitting from either outside or inside the network.

The preferred algorithm continues cataloging packets in connection with a specific packet daemon until a user-defined sample time set in the packet daemon configuration file expires. After the sample time expires, the memref, as shown in FIG. 2, is preferably reset (e.g., qw1232ewr23=0) and the process again monitors the port for attack profiles based upon the system defined parameters, such as the count number of data packets from a single source.

With respect specifically to cataloging, such process occurs only if the system's logging is enabled. If enabled, the cataloging function preferably creates a small ASCII file which provides information captured from the data packets, including for example source and destination MAC addresses and IP Addresses, packet type, packet size and destination port. This file is preferably transmitted using a secure channel on a short-time based interval to a large RDBMS.

Sorting of data is preferably provided using a relational model that can sort data with the following keys:

Source Address

Destination Address

Source MAC Address

Source Destination Address

Protocol Type

Time/date stamp

Using these primary data types, the present invention can sort data type attacks and protocol types to identify new patterns, as well as catalog usage patterns and usage profiles. Using the keys, a hash table can be created to monitor for and determine data attack types depending upon the particular security needs of the network.

Within a router having the IDS 52 with the packet daemon, during operation the packet capture overhead could reduce performance. Preferably, the IDS overhead is configurable to provide a delay for a predetermined period of time after capturing a specified number of packets. For example, after capturing 10,000 data packets, a 10 millisecond may be provided before again capturing data packets.

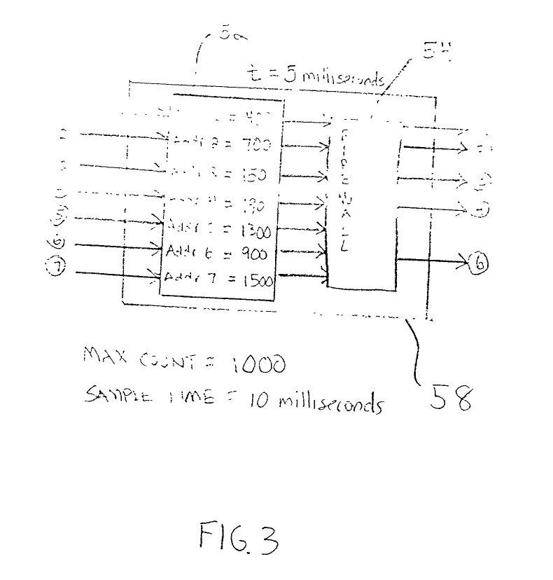

As shown in FIG. 3, an adaptive firewall 54 preferably operates in connection with the sorting and counting procedures of the packet daemon in a router 58. The adaptive firewall is preferably not dependent on a rules based mechanism that has a statically configured monitoring and defense model. These rules would then require modifying and updating to monitor and identify new types of attacks and different attack profiles. The adaptive firewall of the present invention has no “preprogrammed” rules that must be designed to a specific pattern, and thus the network administrator does not have to constantly ensure that the rules are current. The preferred adaptive firewall for use in connection with the present invention must only be provided with two parameters to perform its monitoring operations: a data packet count threshold and a sample time.

The parameters for the adaptive firewall may be provided by, for example, the network system administrator based upon the security policy of that network. The network administrator provides a threshold data packet count value, which represents the maximum number of packets per sample time, and if the number of packets from any one source exceeds the data packet threshold value during the pre-determined sample time, as described above, all data packets from that source will be denied. However, the physical network port preferably remains open for the other data traffic. It should be noted that the denial to the specific source address is preferably automatic, and will be removed only after a predefined lockout period, and only if the transmission of the attacker's traffic has subsided. Preferably, the system provided by the present invention continues to monitor the data ports for data packets from the denied source to determine whether it is in conformance with the predetermined rules based on the sample time and data packet threshold value. Only if the source meets the network rules, and the lockout period (e.g., 20 minutes) has expired, will the network allow transmission of data packets to and from the previously denied source.

With respect specifically to the “hit-count” table, the following data structures are provided: (1) Lockout start command queue: for communication between the packet capture thread 352 and the per-second thread 380. It contains the source and destination IP address pair to be blacked out; (2) In-progress lockout list: list of in-progress lockouts. Contains the locked-out source and destination IP address pair, along with the time that the lockout will end; and (3) ADS buffer pool: contains buffers to be filled by the packet-capture thread 350 for transmission to ADS.

Referring again to FIG. 3, the data packet count threshold is set at 1000 with a sample time of ten milliseconds. As illustrated, the current time is t=5 milliseconds, with data packets from Address (Addr) 5 and Addr 7 violating the denial conditions (i.e., greater than 1000 data packets transmitted in ten milliseconds). Therefore, data packets from Addr 5 and Addr 7 are denied access, while data packets from all other source addresses are permitted to transmit through the router 58.

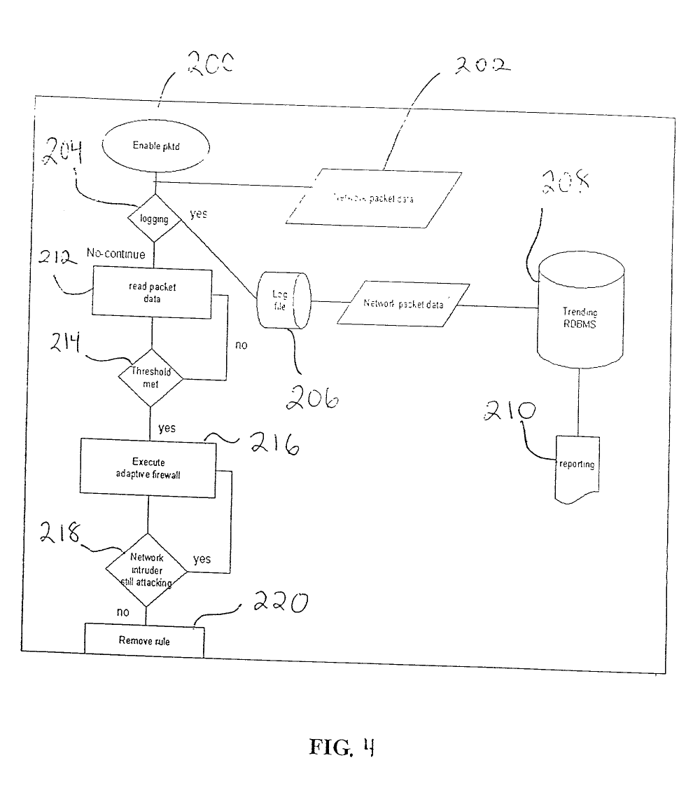

Referring now to FIG. 4, the preferred packet daemon algorithm loops until certain predetermined conditions are met and the process does not exit unless the network administrator configures it for shutdown. As illustrated in FIG. 4, at 200 the packet daemon is activated or enabled which begins the process of monitoring network data packets 202. If logging is enabled as shown at 204, a log file is preferably created at 206 with data from the network packet transmitted and stored in the RDBMS at 208. A report may be provided as needed at 210. If logging is enabled, information from each network packet is stored in the RDMBS. It should be noted that these functions are provided by the multi-threaded IDS 50.

Referring again to the main operation of the packet daemon (i.e., after logging is performed or if logging is not enabled), at 212 the packet data is identified using the packet capture thread 350, including storing of the source address for that packet at a memref location. This memref is preferably a pointer to a software memory location. The algorithm then determines whether the threshold data packets count has been met at 214 using the increment count thread 400 and per-second thread 380. If not, no further action is required and data packets continue to be read by the packet daemon. If the threshold has been met, then at 216 the adaptive firewall is executed (i.e., the network denies access to data packets from the source exceeding the threshold value) using the per-second thread 380 and increment count thread 400. Essentially, the network will block data packets from the denied source through the ports of the network while the source is transmitting packets that exceed the predetermined threshold value. At 218, the algorithm determines whether the network intruder is still attacking (i.e., is the denied source address still transmitting data packets across the monitored port) using the packet capture thread 350 and pre-second thread 380. The preferred system continues to monitor and count the number of data packets being transmitted from the denied source using the increment count thread 400. If the intruder (which may be an internal or external intruder) is still transmitting in violation of the predetermined rules, then the firewall continues to deny access to data packets from that source. If the intruder is not transmitting, or is now transmitting within the threshold limits, then at 220, the rule is removed (i.e., denial is removed) using the per-second thread 380. However, the system administrator may decide that regardless of whether transmission from the denied source has terminated, no data packets from that source should be allowed access for a predetermined period of time (i.e., a lockout). If this is the case, then denial of access is continued at 216 until the expiration of this period. If the memrefs have not been reset during the period of denial, then only the memref for the denied source address will be reset at 220.

With respect specifically to the configurable parameters of the monitoring system 50, the following are preferably provided: (1) packet capture overhead tunables: number of packets to capture before delaying and length of delay in milliseconds; (2) lockout tunables: sample period in seconds, “hit” count threshold, and length of lockout period in seconds; and (3) ADS connection: IP address and TCP port.

The TLIDS Embodiment

In the TLIDS embodiment of the present invention, it is recognized that certain protocols, e.g. File Transfer Protocols (FTP)result in high traffic flow over a port, while others (e.g. DNS) generate a much lower traffic flow over a port. Providing an analysis of the protocol in combination with an improved system of rules to be implemented as selected from a rule making decisional tree provides greater flexibility in the identification of an attack and in the responses thereto.

The response disclosed by the inventors above was primarily directed to denial of access when denial conditions where met, which denial was removed after a lockout period if the transmitting source was no longer transmitting attack data packets.

While denial certainly remains a response in this alternative embodiment of the present invention additional responses in this embodiment of the present invention include an “alert” response which entails sending an alert to the system administrator or other supervisory personnel or devices, a “throttling” response which queues packets and sends them out at a controlled rate, and a “redirection” response, wherein the attack from the source is redirected to another destination selected by the system administrator or other supervisory personnel or devices so that the attack can be captured and analyzed as desired or required.

The newly developed responses are made possible in this embodiment of the present invention because it does not simply look at source and destination, determining the number of packets from each source traversing the data ports during a predetermined period of time and denying access to the data ports to data packets from a particular source if the number of packets traversing the ports from that source was greater than a predetermined number during the predetermined period of time. Instead, the present inventors have realized that an analysis of the protocol used to send the data packets is also important, as certain types of protocols by their nature generate high traffic while others do not. Analyzing traffic flow versus protocol employed provides a much more accurate determination and identification of denial of service attacks Thus the present invention monitors source address, destination address, destination port, source port and protocol, and when parameters are exceeded indicating an attack is in progress in combination with the below described rules tree, this embodiment of the present invention can respond with an alert, denial of service, request for throttling, redirection and combinations thereof in response to the attack. In short, a user specifies a set of attack parameters and a set of responses to be taken when the attack parameters have been met. The Radix rules tree is used to coordinate the attack parameters and the response.

In addition to greater flexibility in response and greater accuracy in identifying the attack, this embodiment of the present invention also introduces flexibility in that the above described system denied all service from a source when parameters were exceeded during the lockout period while this embodiment of the present invention, by analyzing the protocol and other parameters, can deny service not simply based upon source address but upon any combination of these parameters as determined by the rules tree. Thus a source that is transmitting from one source address both attack with a first protocol and non-attack data packets via a second protocol can be permitted to continue to sending the non-attack data packets as opposed to denying all data packets from that source address. Faster analysis and rule association is permitted using a Radix decisional tree structure.

In addition to the configuration script described above wherein certain parameters (e.g. threshold hit values and time intervals) are selected by the system administrator, in this embodiment of the present invention the system administrator may select rules that affect certain data packets based on source address, source port, destination address, destination port, protocol or other parameters. The system administrator may draft these rules at the source code level, and/or higher level functionality, (e.g. graphical user interfaces (“GUIs”) may be employed to assist the drafter of the rules.

The use of a rules based system is limited by the data structure used to catalog and implement the rules. The data structure must be robust enough to select the appropriate rule and to implement the rule quickly enough to avoid substantially slowing the IDS system.

In this embodiment of the invention, the rules are coordinated in a Radix tree, which is a well known programming tool resembling a tree trunk and branching decision making model. Utilizing such a model, entire sets of rules may be implemented or dismissed as the decision making proceeds along branches of the decision making tree greatly speeding the selection and application of the appropriate rule for the parameter(s) being analyzed.

In short, the rules are stored on nodes in the Radix tree, and certain actions (e.g. alert, deny, throttle, redirect or combinations thereof) are associated with the rule. Hash tables may also be associated with the rules nodes for rules relating to specific parameters. For example, where an “any” item in terms of, for example, source address or port, destination address or port or protocol is identified for specific treatment, upon the presentation of that item to the IDS the hash table is consulted for the appropriate rule to apply.

The TLIDS engine provides a mechanism for detecting and preventing anomalous traffic passing through a router or other system, and provides greater utility, flexibility and speed than has heretofore been known.

In specifying the rule set for programming the TLIDS engine, it is important that any combination of source and destination addresses and ports can be specified as “any” or “all”. An “any” instructs the TLIDS engine to track different values individually, while an “all” instructs the TLIDS engine to track the aggregate. For example, if a rule states that “from any in 0.0.0.0/0”, packets from 192.168.1.1 address and 192.168.1.2 address will be tracked separately, whereas if the rule were to say “from all in 0.0.0.0/0”, the data from these addresses would accumulate in the same rule.

For example, the following represent valid rules:

if data from any to all in 192.168.0.0/16 proto udp>5 k/s then \ for 10 m deny traffic

if data from all to all in 192.168.0.0/16 proto icmp>15 k/s then \ send alert then for 10 m deny traffic.

The rule set in Backus-Naur form (BNF) is provided below:

rule := ‘if data’ track threshold responses | ‘ads is on’

host port

| tract := ‘from’ [host] [port] ‘to’ [host] [port] [proto] | |
|---|---|
| proto := ‘proto’ protocol | |
| host := anyall \| anyall [‘not’] ‘in’ host[/mask] \| host | |
| port := ‘port’ [‘not’] ‘in’ int-int | |
| anyall := ‘any’ \| ‘all’ | |
| threshold := ‘>’ float ‘k/s’ | |
| responses := response \| responses response | |
| response := ‘then’ [fortime] actions | |
| fortime := ‘for’ time | |
| actions := action \| actions ‘and’ action | |
| action := | [‘send alert’] \| |
| | [‘throttle connection to’ float k/s] \| |
| | [‘deny traffic’] \| |
| | [‘reroute to’ host]. |

Another example of a suitable BNF form for a rule

set is as follows:

Rule := tlids
Tlids := ‘if traffic’ track threshold responses
Track := ‘from’ [host] [port] ‘to’ [host] [port] [proto]
Proto := ‘proto’ protocol
Host := anyall | [anyall] [‘not’] [‘in’] host[/mask]
Port := ‘port’ anyall | ‘port’ [anyall] [‘not’] [‘in’]

int[−int]

Anyall := ‘any’ | ‘all’
Threshold := ‘>’ float ‘k/s’
Responses := response | responses response
Response := ‘then’ [fortime] actions
Fortime := ‘for’ time
Actions := action | actions “and” action
Action := ‘send alert’ |

‘throttle traffic to’ float k/s |
‘deny traffic’ |
‘reroute traffic to’ host

The rules supplied by the user or system administrator are preferably parsed into the rules tree. Each leaf of the tree corresponds to one or more rules that the user has provided. A leaf will have multiple rules only if the user has specified in two rules the same source and destination addresses but different netmasks.

Such a rules tree has an important property in that entire leaves, and in turn the time to examine the rules contained therein, can be eliminated as there is no need to test that leaf.

When TLIDS is executed, options are processed, and the TLIDS tries to parse a configuration file. If TLIDS is unable to find or parse this file, TLIDS exits. Five threads, which are discussed below, are then created. The main thread then attempts to join the packet capture thread, and if the joining is successful, a cleanup procedure is invoked and the TLIDS exits.

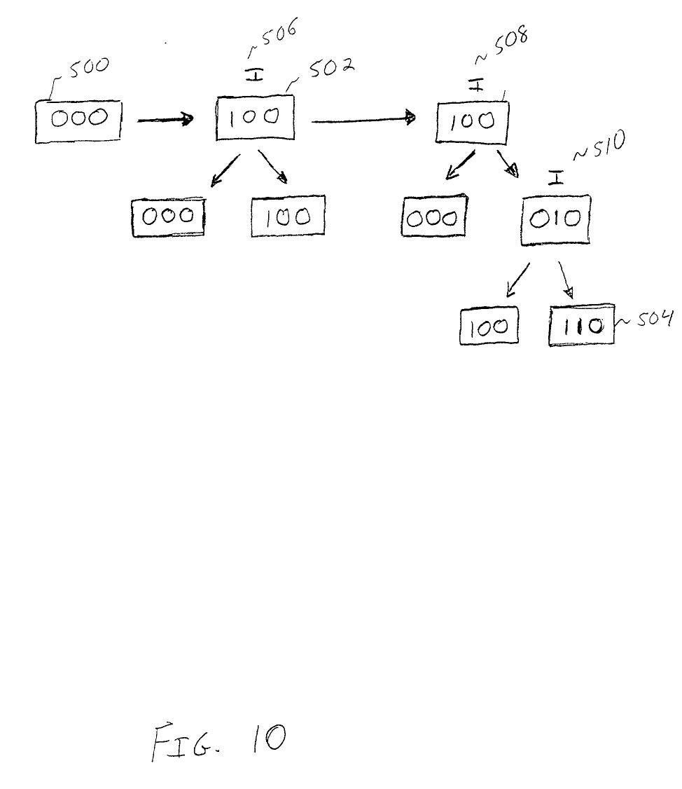

Referring now to FIG. 10, the rules supplied by the user are parsed into a rules tree. The rules tree is a radix tree, formed by comparisons between the supplied source and destination addresses. Each leaf of the tree corresponds to one or more rules that the user has provided. A leaf will have multiple rules only if the user has specified in two rules the same source and destination addresses, but different netmasks.

The tree thus constructed has an important merger property, which will be illustrated using simplified 3 bit addresses 500, 502 and 504. FIG. 10 shows the construction of a radix tree for the addresses 000, 100 and 110. The internal nodes 506, 508 and 510 created by the merging process hold a 1 in the position in which its immediate descendants differ and a 0 everywhere else. Notice that the associated netmasks are not specified, as we do not construct the radix tree using any netmask information, but each leaf has a set of rules, each of which contains a netmask.

A critical observation is that by traversing the tree in the proper way, if a rule's address contains a 1 in position i, and an incoming packet's address contains a 0 in position I, the packet cannot match the rule, regardless of what netmasks may be associated with the rule. Using this property we find that when a leaf is reached through the normal radix search procedure, we can rule out all rules in any leaf to the right of this leaf. For example, referring to FIG. 1, if we are presented with the address 100 at 502, the radix search will lead us to the leaf marked 100 at 502. We know from the position of this node that the rules in the leaf marked 110 cannot possibly match, and needn't waste time testing that leaf. In other words, if the Radix comparison dictates that an examination be made of the left child of a node, there is no need to examine the right child of that node.

A natural way to search this tree for matches is an algorithm that is recursive when taking a step to the right, but iterative when taking a step to the left. The algorithm must also take a step to the left after any step to the right has returned.

As mentioned above, rules contained in the leaves of a radix tree constructed from the values of the rule's source and destination addresses. The nodes of this tree simply have two 32 bit quantities (for the radix comparisons), pointers to the node's left and right descendants (if any), or a pointer to a leaf structure if there are not descendants. The leaf structure contains a mutex, so that the packet and bookkeeper threads cannot access the leaf simultaneously. Rules may have the same source and destination addresses with different netmasks, so the leaf contains a linked list of rules. The rules are stored in data structures which, unfortunately, are presently called nodes, for historical reasons (the tree was once constructed from these). These “nodes” contain all the information a rule conveys: source and destination addresses and masks, protocol, maximum rate, port ranges, etc. There is also an array of linked lists of actions (more on the action structure later). If any “anys” have been specified in the rule, a hash is used to track the various connections. This hash is an adaptive hash; that is the number of “buckets” it uses grows if the number of connections it is tracking becomes larger than a certain threshold.

A rule may specify arbitrarily many responses (conjoined by a “then”), and within each response there may be arbitrarily many actions (conjoined by an “and”). It is natural, therefore, to store these in an array of linked lists within the node structure. The action structure contains an integer type, and the data necessary to effect the action (presently a host name or rate).

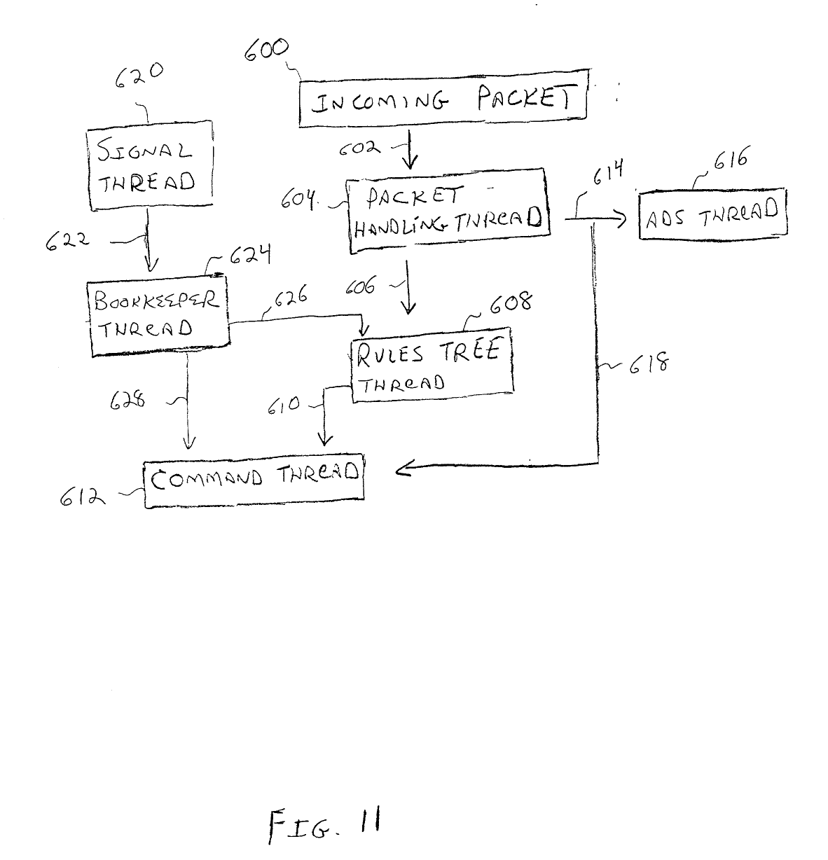

Referring now to FIG. 11, there are illustrated the five threads of the TLIDS system and their communications channels of this embodiment of the present invention.

An incoming packet 600 is presented as indicated by arrow 602 to a packet handling thread 604 which reads packets off the network and updates a rules tree thread 608 based on the packet's data as indicated by arrow 606. If conditions warrant based on the rule set, a message is sent as indicated by arrow 610 to a command thread 612. Optionally, portions of the packet data can be sent as indicated by arrow 614 to an ADS thread 616 for further processing. The optional ADS thread 616 sends critical data as indicated by arrow 618 from received packets to a configurable destination for further processing (e.g., command thread 612).

A signal handling thread 620 configures itself to receive a reminder (“SIGALRM”) every second (and wakes up as indicated by arrow 622 a bookkeeping thread 624 upon receipt) and handles other signals, such as URG.

The bookkeeping thread 624 is responsible for maintaining the rule tree thread 608 over time as indicated by arrow 626.

The command thread 612 executes all commands specified in the rules. This includes ipchains rules, and traffic control (“tc”) commands which are constructed based on the information contained in both the node and the actions being performed.

In other words, lists of actions are stored within nodes. The node is sent to the action thread with an instruction to add or remove. The command thread executes commands (ip, tc, ipchains, etc) to implement the specified action.

The inter-thread communications channels operate as follows. All communications to the command thread 612 are done through a System V (“SYSV”) style message queue. The System V message queue is believed to be provided by Novell, Inc., under the SYSV trademark. The messages passed to the command thread 612 consist of a pointer to the “node” in the rules tree, which, recall, represents a rule, as well as an action number and a boolean value that tells the command thread 612 if it should perform or undo the actions. The action number is an index into the array of action lists that tells the command thread 612 what actions to perform.

If the ADS thread 616 has been activated, ADS packets are placed into a ring by the packet handling thread 604. When data is ready for delivery, the packet handling thread 604 posts to a semaphore to let the ADS thread 616 know that data is available.

The bookkeeper thread 624 decrements every time counter in the rules tree 608. In certain cases this means that an action has expired, and a message is sent to the command thread 612 as indicated by the arrow 628. In other cases, nodes are simply deleted from a hash table. If an action timer expires while being updated by the bookkeeper THREAD 624, a message is sent to the command thread 612 to undo the actions that had been performed by this node.

The signal thread 620 primarily functions to awaken the bookkeeper thread 624 once per second. The signal function thread 620 uses setitimer to deliver itself a SIGALRM once per second. Upon receipt, a counter is incremented and the signal thread 620 determines if the bookkeeper thread 624 is running (meaning it has not completed the previous iteration's run). In this case, it simply waits for the next signal to arrive. This way, the next time the bookkeeper thread 624 is awakened, it is told to use a time argument higher than 1 when updating the rules tree thread 608. Using this scheme, clock drift should not occur for more than a few seconds at a time and only under extreme loads. This provides a means to ensure that if an action is specified to last for a certain time period, it does not last for a significantly longer amount of time. The signal thread 620 also handles miscellaneous signals such as SIGNAL (“SIGINT”). The SIGINT (interrupt) signal is used as described above. The SIGHUP (hangup) signal is used to restart the service. This usage is consistent with current common practices.

While denial certainly remains a response in the present invention, the addition of the RADIX rules tree enables utilization of any number of responses based upon rules set forth in the RADIX tree. For example, as noted above, newly added responses may include but certainly are not limited to an “alert” response which entails sending an alert to the system administrator or other supervisory personnel or devices, a “throttling” response which queues packets and sends them out at a controlled rate, and a “redirection” response, wherein the attack from the source is redirected to another destination selected by the system administrator or other supervisory personnel or devices so that the attack can be captured and analyzed as desired or required.

The newly developed responses are made possible by this embodiment of the present invention because it does not simply look at source and destination, determining the number of packets from each source traversing the data ports during a predetermined period of time and denying access to the data ports to data packets from a particular source if the number of packets traversing the ports from that source was greater than a predetermined number during the predetermined period of time. Instead, the present inventors have realized that an analysis of the protocol used to send the data packets is also important, as certain types of protocols by their nature generate high traffic while others do not. Analyzing traffic flow versus protocol employed and source port, source address, destination port and destination address, and developing rules based upon that analysis and employing those rules via a RADIX table, provides a much more accurate and flexible identification of denial of service attacks and formulation of responses thereto. Thus the present invention monitors source address, destination address, destination port, source port and protocol, and when parameters are exceeded indicating an attack is in progress, it can respond among other ways, with an alert, a denial of service, a request for throttling, a redirection and combinations thereof in response to the attack.

There are other various changes and modifications which may be made to the particular embodiments of the invention described herein, as recognized by those skilled in the art. However, such changes and modifications of the invention may be constructed without departing from the scope of the invention. Thus, the invention should be limited only by the scope of the claims appended hereto, and their equivalents.

We claim:

1. A method of protecting a network from potentially harmful data traffic traversing a plurality of data ports of the network, the data traffic comprising data packets, the method comprising the steps of:
a. providing a means for monitoring attributes of data traffic traversing a plurality of data ports of a network;
b. providing a means for responding when an attack on said network is determined to occur;
c. defining a set of attack parameters from attributes of one or more data packets traversing a network, such that when said defined set of parameters are met an attack on said network is presumed to occur;
d. specifying a set of responses that may be taken in response to said attack, wherein said responses are defined by a set of response rules, said response rules being designed to select one or more of said responses from said set of specified responses based upon monitored attack parameters;
e. monitoring all the data packets traversing the data ports from a plurality of sources with said monitoring means to determine when said attack parameters have been met;
f. comparing and coordinating said attack parameters and said response rules to select one or more of said set of specified responses based upon said monitored attack parameters; and
g. providing said one or more selected responses through said response providing means to protect said network from said attack.

2. The method of claim 1 wherein said set of responses is selected from the group consisting of a denial of access response, an alert response wherein an alert of said attack is provided, a throttling response wherein data packets are queued and sent along the network at a controlled rate, a redirection response wherein the attack from an attacking source is redirected to another destination, and combinations thereof.

3. The method of claim 1 or 2 wherein said step of comparing and coordinating said attack parameters and said response rules utilizes a Radix tree.

4. The method of claim 1, 2 or 3 wherein said means for monitoring attributes of data traffic traversing a plurality of data ports of a network is through non-promiscuous packet capturing on the firewall device.

5. The method of claim 1, 2 or 3 wherein said means for responding when an attack on said network is determined to occur is through insertion of flow control rules on the firewall device.

6. The method of claim 1 wherein said attributes of said data packets are selected from the group consisting of a data packet's source address, a data packet's destination address, a data packet's source port, a data packet's destination port, the number of data packets from a source address per unit of time; the number of data packets from a source port per unit of time, a data packet's protocol, and combinations thereof.

7. The method of claim 6 where said response is selected based upon said data packet attributes selected from the group consisting of a data packet's source address, a data packet's destination address, a data packet's source port, a data packet's destination port, the number of data packets from a source address per unit of time; the number of data packets from a source port per unit of time, a data packet's protocol, and combinations thereof.

8. The method according to claim 2 wherein the step of denying access to the source is automatic.

9. The method according to claim 1 further comprising the step of copying each of the data packets for monitoring.

10. The method according to claim 1 wherein the step of monitoring further comprises monitoring both incoming and outgoing data packets traversing the data ports.

11. The method according to claim 1 where the step of monitoring further comprises separately monitoring the data packets traversing each of the data ports.

12. The method according to claim 2 further comprising allowing data packets from sources other than the denied source to traverse the data ports.

13. The method according to claim 2 further comprising allowing packets from protocols other than the denied protocol to traverse the data ports.

14. The method according to claim 1 wherein said response rules are user defined.

15. A system for protecting a network, the system comprising a data monitoring means programmed to sample data packets transmitted to and from the network, a memory for storing the sampled data packets and a processor for comparing and coordinating selected attack parameters based upon attributes of said data packets and a set of specified responses defined by one or more response rules to select one or more of said set of specified responses based upon said monitored attack parameters and provide said one or more selected responses to protect said network from said attack.

16. The system according to claim 15 wherein said attributes are selected from the group consisting of a data packet's source address, a data packet's destination address, a data packet's source port, a data packet's destination port, the number of data packets from a source address per unit of time; the number of data packets from a source port per unit of time, a data packet's protocol, and combinations thereof.

17. The system according to claims 15 or 16 wherein said response is selected from the group consisting of a denial of access response, an alert response wherein an alert of said attack is provided, a throttling response wherein data packets are queued and sent along the network at a controlled rate, a redirection response wherein the attack from an attacking source is redirected to another destination, and combinations thereof.

18. The system of claim 17 wherein said attack parameters and said response rules are coordinated using a Radix tree.

19. The system of claim 15 wherein said data monitoring means, said memory and said processor are contained within a router.

20. The system of claim 19 wherein said router is one rack unit in height.

21. The system of claim 20 wherein said router is used in combination with a computer firewall.
